(19) United States
(12) Patent Application Publication
(10) Pub. No.: US 2006/0068632 A1
(43) Pub. Date: Mar. 30, 2006

(54) Heat sink for clipping protecting cover of central processing unit socket

(75) Inventor: Jui Hua Lin, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/236,537

(22) Filed: Sep. 28, 2005

(30) Foreign Application Priority Data
Sep. 30, 2004 (TW) 093129728

(51) Int. Cl. H01R 13/60

(52) U.S. Cl. 439/528

(57) ABSTRACT

A heat sink is for clipping a protecting cover of a central processing unit (CPU) socket. The heat sink includes a bottom part, a plurality of fins, and a clipping part. In this case, the fins are disposed on the bottom part. The clipping part extends from the fins and is used for clipping the protecting cover of the CPU socket. The clipping part has an indentation disposed on the top of the fins for clipping the protecting cover.

### BACKGROUND OF THE INVENTION

1. Field of Invention

The invention relates to a heat sink and, in particular, to a heat sink used for a computer chip.

2. Related Art

The Central Processing Unit (CPU) is the primary processing and calculating unit in a computer. According that the CPU itself is sensitive to temperature, the industry still cannot weld the CPU directly to the main board. Thus, a CPU socket is needed on the main board for installing the CPU. The first step of installing a CPU is to fix the CPU socket on the main board. Then the CPU is inserted into the CPU socket so as to finish the assembling of the CPU and the main board.

Referring to FIG. 1 and FIG. 2, a conventional CPU socket module 10 includes an upper cover 11, a socket 12 and a base 13, which are stacked in sequence. The upper cover 11 has an opening 111 allowing a CPU 14 to contact directly to a heat sink after the completely installation. Besides, the surface of the socket 12 has a plurality of pins 121, which electrically connect with the CPU 14. Herein, the pins 121 can be elastic slice pins or needle pins.

Since the upper cover 11 has the opening 111, the improper forces may occur and deform the pins 121 before assembling the CPU 14. For example, the user may carelessly press the pins 121 and result in the deformation of the pins 121. The deformed pins 121 may lead to failure of conduction at some connection points. Thus, as shown in FIG. 1 and FIG. 2, a protecting cover 15 is usually provided to cover the surface of the upper cover 11 of the CPU socket module 10. In this configuration, the vulnerable pins 121 can be protected by closing the upper cover 11.

However, referring to FIG. 1 and FIG. 2, the protecting cover 15 has to be removed when the user installs the CPU 14 on the CPU socket module 10. Thus, the CPU surface is exposed to provide functioning and the protecting cover 15 has to be stored up by the user. If the main board 16 has to be delivered for repairing, the user has to put back the protecting cover 15 on the CPU socket module 10 to protect the pins 121 of the CPU socket module 10 from destruction during transportation. Permanently storing the protecting cover 15 is very inconvenient for the user; even the protecting cover 15 may be very easily missed due to carelessness.

It is therefore a subject of the invention to solve the above-mentioned problem of storing the protecting cover for the CPU socket module.

### SUMMARY OF THE INVENTION

In view of the foregoing, the invention is to provide a device that can store a protecting cover for a CPU socket so that an existing element of a main board, such as a heat sink, can be used to clip the protecting cover for the CPU socket.

To achieve the above, a heat sink for clipping a protecting cover of a CPU socket includes a bottom part, a plurality of fins, and a clipping part. The fins are disposed on the bottom part, and the clipping part extends from part of the fins and has an indentation, which is disposed on the top of the fins for clipping the protecting cover of the CPU socket.

In addition, to achieve the above, a heat sink for clipping a protecting cover of a CPU socket includes a bottom part, a plurality of fins, and a clipping part. The fins are disposed on the bottom part, and the clipping part extends from part of the fins and is used for clipping the protecting cover of the CPU socket.

As mentioned above, the heat sink may have at least one clipping part for clipping the protecting cover of the CPU socket. Therefore, it is no problem for the user to keep a space to place the protecting cover, which is originally used for protecting pins of the CPU socket, after the CPU is installed on the CPU socket. Furthermore, because the clipping strength is so strong, the protecting cover can be firmly clipped in the clipping part of the heat sink during transportation. Besides, that using the heat sink disposed adjacent to the CPU to clip the protecting cover of the CPU socket fits in with users' habit. According that the protecting cover is disposed in a notable place, and it will not be ignored when sending for repairing in the future.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing the conventional CPU socket module and the CPU;

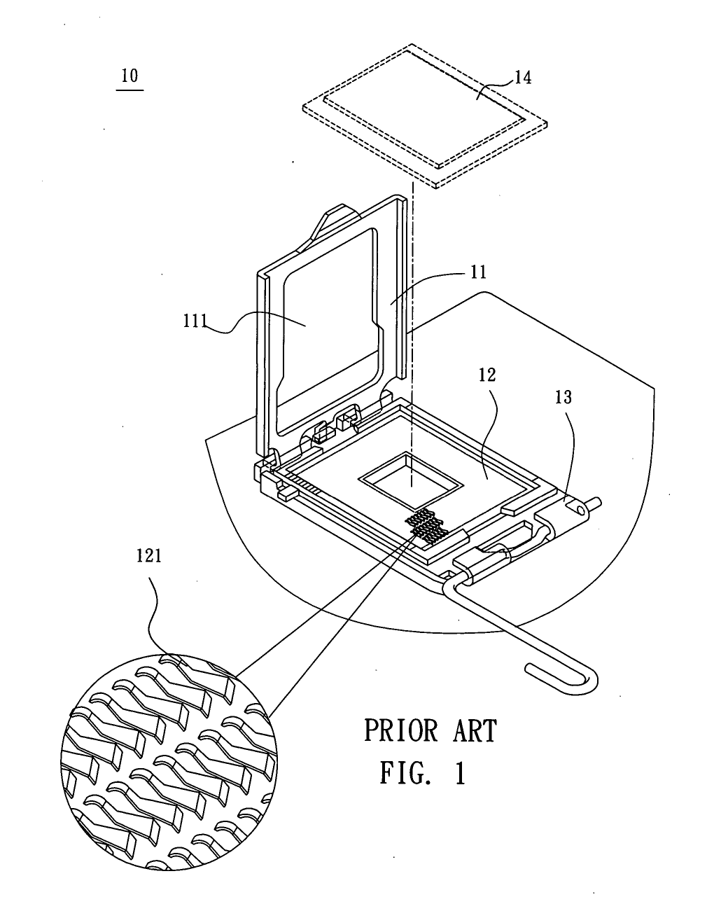

FIG. 2 is a schematic illustration showing the conventional CPU module and the protecting cover;

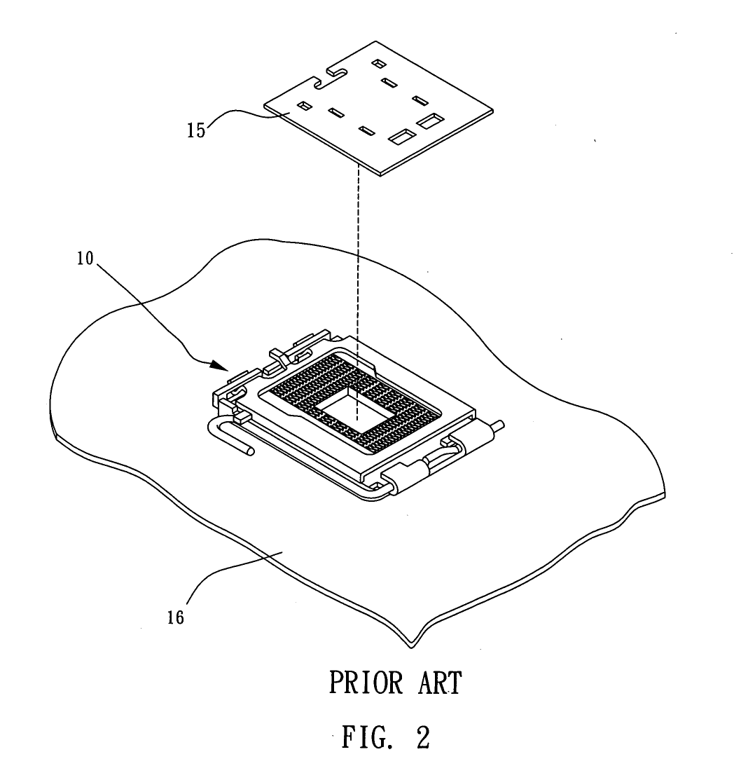

FIG. 3 is a 3-dimentional illustration showing a heat sink according to an embodiment of the invention;

FIG. 4 is another schematic illustration showing a heat sink according to an embodiment of the invention, wherein the heat sink is to be installed on a chip; and

FIG. 5 is a schematic illustration showing a heat sink according to another embodiment of the invention.

### DETAILED DESCRIPTION OF THE INVENTION

The present invention will be apparent from the following detailed description, which proceeds with reference to the accompanying drawings, wherein the same references relate to the same elements.

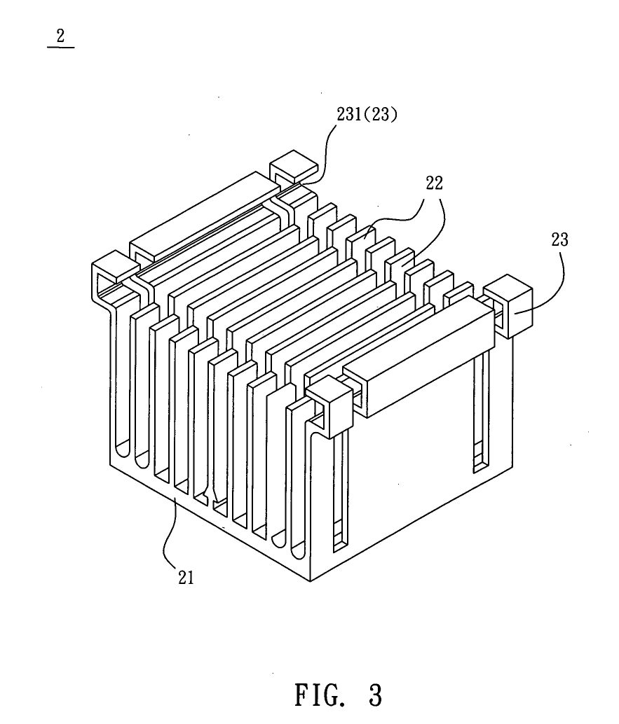

Firstly, please refer to FIG. 3 to illustrate a heat sink 2 according to a preferred embodiment of in the invention.

The heat sink 2 includes a bottom part 21, a plurality of fins 22 and at least one clipping part 23. In this embodiment, the heat sink 2 can be used for a central processing unit chip, a north-bridge chip, a south-bridge chip, or other chips. The material of the heat sink 2 can be copper or other metal or alloy with better heat conductivity.

As shown in FIG. 3, the fins 22 are parallel disposed on the bottom part 21. To be noted, the aspect, size and arrangement of the fins 22 of the heat sink 2 can be changed with demands, and should not be limited in this embodiment.

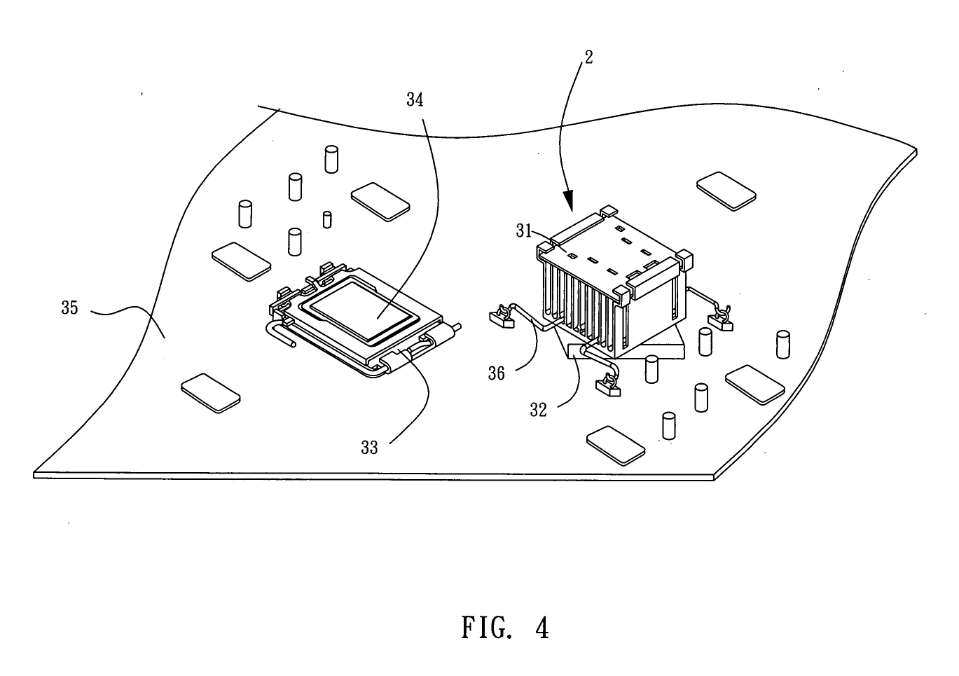

One of the main characteristics of this invention is that of the heat sink 2 has the clipping part 23 for carrying the protecting cover 31 of the CPU socket, as shown in FIG. 3 and FIG. 4. The heat sink 2 includes at least two clipping parts 23, which extend from two of the fins 22. In this embodiment, the clipping parts 23 extend from the two fins 22 positioned at the two ends. Surely, the part of the fins 22 from which the clipping part 23 are extended can be varied with demand. In this case, as the clipping parts 23 are, for example, indentations 231, the openings of the indentations 231 are set opposite to one another. The cross-section of the indentation 231 can be an arc, and U-shape or other shapes as long as it can clip the protecting cover 31.

Referring to FIG. 4, the heat sink 2 is used for clipping the protecting cover 31 of the CPU socket. In the embodiment, the heat sink 2 is disposed on, for example, a north-bridge chip 32. The north-bridge chip 32 is disposed adjacent to a CPU socket module 33, and a CPU 34 is disposed on the CPU socket module 33. The north-bridge chip 32 and the CPU socket module 33 are disposed on a main board 35.

As shown in FIG. 3 and FIG. 4, the protecting covering 31 of the CPU socket, which is originally covering the CPU socket module 33, can be clipped in the indentation 231 after being taken off. Users can slightly pull open the clipping part 23 of the heat sink 2 and dispose the CPU protecting cover 31 in the indentation 231. In this case, since the protecting cover 31 is clipped by the clipping part 23, it can be fixed on the heat sink 2. Accordingly, the protecting cover 31 would not be removed easy so as to achieve the storage thereof.

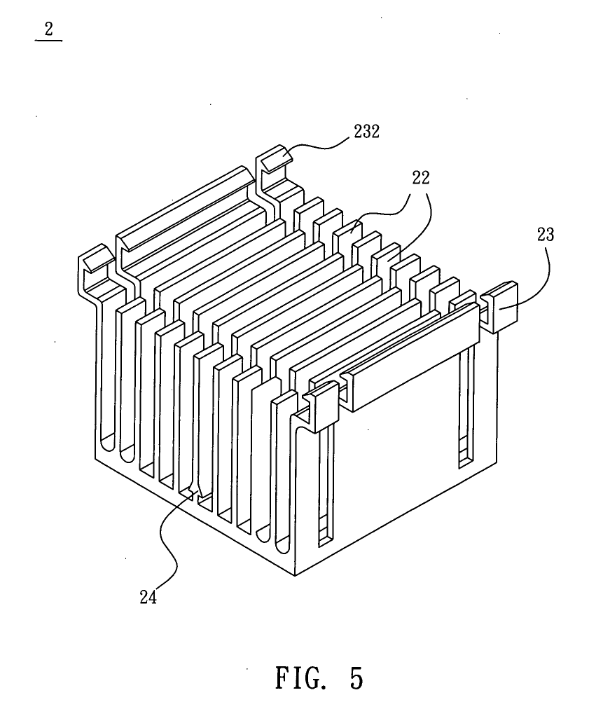

Besides, referring to FIG. 5, the clipping part 23 according to another embodiment of the invention can further include an incline 232. The incline 232 of the clipping part 23 is disposed next to the indentation 231 and an angle is formed between the incline 232 and bottom part 21. Along the inclines 232, users can press in the protecting cover 31 from the top of the heat sink 2 to make the protecting cover 31 disposed in the clipping part 23 of the heat sink 2.

To be noted, the clipping part 23 of the heat sink 2 of the invention should not be limited to the aspects which have been described with reference to the specific embodiments, and any structure of the heat sink that can chip or fix the protecting cover 31 can achieve the spirit of the invention.

As mentioned above, the heat sink for clipping a protecting cover of this invention includes the following advantages:

1. There is no problem for the user to keep a space to place the protecting cover of the CPU socket, which is originally used for protecting the CPU socket pins, after the CPU is set on the CPU socket;

2. Because the clipping strength is so strong, the protecting cover of the CPU socket is firmly clipped in the clipping part of the heat sink during transportation;

3. The protecting cover of the CPU socket of the invention uses the existing element (heat sink) of the main board to solve the problem of the user simply by changing the design of a part of the heat sink, and, meanwhile, no cost is increased; and

4. Use of the heat sink disposed next to the CPU as the clipping portion for clipping the protecting cover of the CPU socket fits in user's habits. Since the protecting cover is disposed in a notable place, it will not be ignored when sending for repairing in the future.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A heat sink for clipping a protecting cover of a central processing unit (CPU) socket, comprising:
a bottom part;
a plurality of fins disposed on the bottom part; and
a clipping part extending from the fins and having an indentation, wherein the indentation is disposed on a top of the fins for clipping the protecting cover of the CPU socket.

2. The heat sink according to claim 1, wherein the heat sink is used for a north bridge chip, a south bridge chip or a central processing unit chip.

3. The heat sink according to claim 1, wherein the cross-section of the indentation is an arc or a U-shape.

4. The heat sink according to claim 1, wherein the protecting cover of the CPU socket is clipped in the indentation.

5. The heat sink according to claim 1, wherein the clipping part further has an incline disposed adjacent to the indentation.

6. The heat sink according to claim 5, wherein the incline and the bottom part form an angle.

7. An heat sink for clipping a protecting cover of a CPU socket, comprising:
a bottom part;
a plurality of fins are disposed on the bottom part; and
a clipping part extending from the fins for clipping the protecting cover of the CPU socket.

8. The heat sink according to claim 7, wherein the heat sink is used for a north bridge chip, a south bridge chip or a central processing unit chip.

9. The heat sink according to claim 7, wherein the clipping part has an indentation.

10. The heat sink according to claim 9, wherein the cross-section of the indentation is an arc or a U-shape.

11. The heat sink according to claim 9, wherein the protecting cover of the CPU socket is clipped in the indentation.

12. The heat sink according to claim 9, wherein the clipping part further has an incline disposed adjacent to the indentation.

13. The heat sink according to claim 12, wherein the incline and the bottom part form an angle.
